(19) United States
(12) Patent Application Publication
(10) Pub. No.: US 2009/0226792 A1
(43) Pub. Date: Sep. 10, 2009

(54) Vehicle Having Fuel Cell

(75) Inventor: Kenichi Hamada, Kanagawa-ken (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 11/992,945

(22) PCT Filed: Nov. 6, 2006
(86) PCT No.: PCT/IB2006/003119

§ 371 Date: Apr. 1, 2008

(30) Foreign Application Priority Data
Nov. 7, 2005 (JP) 2005-321735

(51) Int. Cl. H01M 2/02; B60N 2/02

(52) U.S. Cl. 429/34; 296/65.01

(57) ABSTRACT

A vehicle includes a front seat that is slid with respect to a vehicle body backward and forward in order to adjust the seating position of an occupant. A fuel cell is attached to the bottom face of the front seat.

### BACKGROUND OF THE INVENTION

1. Field of the Invention

The invention relates to a vehicle having a fuel cell.

2. Description of the Related Art

Vehicles having a fuel cell have been developed. In such vehicles, a fuel cell is attached to a vehicle body. For example, Japanese Patent Application Publications No. JP-A-2004-122972 and No. JP-A-2004-187485 describe that a fuel cell is arranged on the floor at a position under a seat. Thus, the space under the seat is effectively utilized, and, consequently, more space is provided for an occupant.

Usually, seats are slid backward and forward to adjust the seating positions of occupants. Therefore, when a fuel cell is attached onto the floor at a position under the seat as described in the Japanese Patent Application Publications No. JP-A-2004-122972 and No. JP-A-2004-187485, if the seat is slid, the fuel cell may be exposed and obstruct the positioning of the occupant's legs.

### SUMMARY OF THE INVENTION

The invention provides a vehicle having a fuel cell, in which more space is provided for an occupant by effectively utilizing the space under a seat, and the fuel cell does not obstruct the positioning of the occupant's legs even if the seat is slid.

An aspect of the invention relates to a vehicle having a fuel cell. The vehicle includes a seat that is moved with respect to a vehicle body to adjust the seating position of an occupant. The fuel cell is arranged under the seat and moveable together with the seat.

According to the aspect of the invention, the fuel cell is not fixed to the vehicle body, but attached to the seat. Therefore, when the seat is slid in order to adjust the seating position, the fuel cell is moved together with the seat. Accordingly, even when the seat is slid, the fuel-cell is not exposed. In other words, in the vehicle having a fuel cell according to the aspect of the invention, more space is provided for the occupant by effectively utilizing the space under the seat, and at the same time, the fuel cell does not obstruct the positioning of the occupant's legs even if the seat is slid.

The vehicle according to the aspect of the invention may further include a fuel gas supply portion that supplies predetermined fuel gas to the fuel cell. The fuel gas supply portion may be fixed to the vehicle, and the fuel cell and the fuel gas supply portion may be connected to each other by a flexible pipe that is deformable and extensible.

Examples of the fuel gas supply portion include a fuel tank that stores fuel gas, and a fuel gas generating device that generates fuel gas from a predetermined raw material. Examples of the flexible pipe that is deformable and extensible include a bellows pipe.

The fuel cell and the fuel gas supply portion are connected to each other by the flexible pipe that is deformable and extensible. Thus, even when the fuel cell is moved while the fuel gas supply portion is fixed to the vehicle, the fuel gas can be supplied from the fuel gas supply portion to the fuel cell due to deformation and extension/contraction of the flexible pipe. Because the fuel gas supply portion is fixed to the vehicle, it is not longer necessary to reserve a space in which the fuel gas supply portion moves in accordance with the movement of the fuel cell. Accordingly, the fuel gas supply portion requires relatively small space.

The vehicle according to the aspect of the invention may include a fuel gas supply portion that supplies predetermined fuel gas to the fuel cell. The fuel gas supply portion may be movable with respect to the vehicle body, the fuel cell and the fuel gas supply portion may be connected to each other by a pipe, and the fuel gas supply portion may be moved in accordance with the movement of the seat and the fuel cell.

Fatigue tends to be caused in the flexible pipe when it is extended/contracted and deformed. Accordingly, a measure needs to be taken to ensure adequate strength of the flexible pipe. The fuel gas supply portion moves in accordance with the movement of the fuel cell, whereby the fatigue caused by the extension/contraction and the deformation of the pipe is suppressed. This leads to improved reliability in pipe strength.

In the vehicle having any one of the structures described above, the seat may be provided with a shelf plate arranged under the seat, and the fuel cell may be attached onto the shelf plate.

In the vehicle having any one of the structures described above, the fuel cell may be arranged under a front seat, and the fuel gas supply portion may be arranged under a rear seat.

### BRIEF DESCRIPTION OF THE DRAWINGS

The foregoing and further objects, features and advantages of the invention will become apparent from the following description of an example embodiment with reference to the accompanying drawings, wherein like numerals are used to represent like elements and wherein:

FIG. 1 is the explanatory view schematically showing the structure of a vehicle 100 according to an embodiment of the invention;

FIG. 2A is the explanatory view showing the structure of a front seat 10, and FIG. 2B is the explanatory view showing the position at which a fuel cell 30 is arranged;

FIG. 3 is the explanatory view schematically showing the structure of a vehicle 100A according to a first modified example of the embodiment; and

FIG. 4A is the explanatory view showing the structure of a front seat 10A according to a second modified example of the embodiment, and FIG. 4B is the explanatory view showing the position at which the fuel cell 30 is arranged in the second modified example.

### DETAILED DESCRIPTION OF THE EXAMPLE EMBODIMENT

Hereinafter, an embodiment of the invention will be described in the following order.
A. Vehicle Structure
B. Modified Examples of the Embodiment

### A. Vehicle Structure:

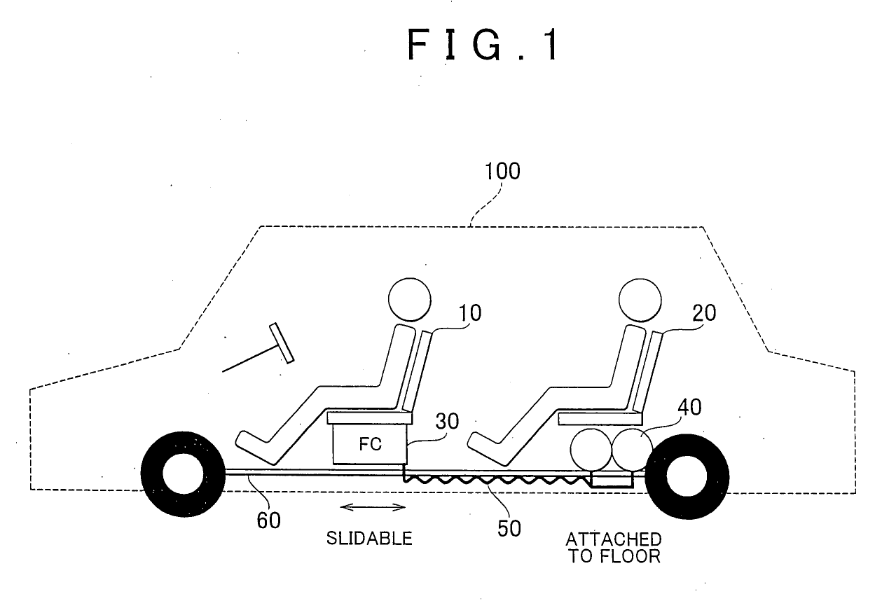

FIG. 1 is the explanatory view schematically showing the structure of a vehicle 100 according to an embodiment of the invention. The vehicle 100 is provided with a fuel cell 30. A motor (not shown) is driven by electric power generated by electrochemical reaction of hydrogen, used as fuel gas, supplied from a hydrogen tank 40 and oxygen in the air, and wheels are turned by the power output from the motor, whereby the vehicle 100 travels.

The vehicle 100 includes a front seat 10 and a rear seat 20. The front seat 10 is slid backward and forward with respect to a vehicle body to adjust the seating position of an occupant. The rear seat 20 is fixed to a floor 60. In the vehicle 100 according to the embodiment of the invention, the fuel cell 30 is arranged in the space under the front seat 10 in order to provide more space for the occupant. The front seat 10 and the position at which the fuel cell 30 is arranged will be described later in detail.

According to the embodiment of the invention, the hydrogen tank 40 is attached to the floor 60 at a position under the rear seat 20. Alternatively, the hydrogen tank 40 may be arranged at another position in the vehicle 100. The fuel cell 30 and the hydrogen tank 40 are connected to each other by a flexible pipe 50 that is deformable and extensible. In the embodiment of the invention, a bellows pipe is used as the flexible pipe 50.

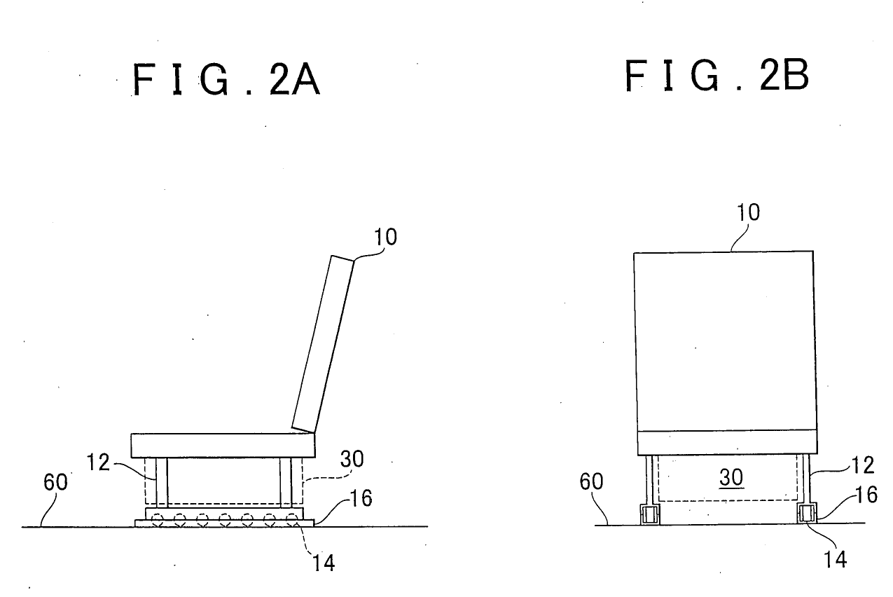

FIGS. 2A and 2B show the structure of the front seat 10 and the position at which the fuel cell 30 is arranged. FIG. 2A is the side view of the seat 10, and FIG. 2B is the rear view of the seat 10.

As shown in FIGS. 2A and 2B, the front seat 10 is provided with a leg portion 12 and a roller portion 14. Further, a rail 16 is laid onto the floor 60. Releasing a stopper (not shown) allows the roller portion 14 connected with the leg portion 12 to slide on the rail 16, whereby the position of the front seat 10 is changed.

In the embodiment of the invention, a space for the fuel cell 30 is left under the bottom face of the front seat 10. The fuel cell 30 is arranged in the space, and fixed to the bottom face of the front seat 10 with bolts (not shown) and nuts (not shown). Note that the dimension of the top face of the fuel cell 30 is set to be smaller than the dimension of the bottom face of the front seat 10 so that the fuel cell 30 arranged in the vehicle 100 is not exposed.

In the vehicle 100 described above, the fuel cell 30 is attached to the front seat 10. Accordingly, when the front seat 10 is slid backward or forward, the fuel cell 30 also slides along with the front seat 10. Thus, the fuel cell 30 is not exposed even when the front seat 10 is slid, unlike the case where the fuel cell 30 is fixed onto the floor 60 at a position under the front seat 10. In other words, in the vehicle 100 having the fuel cell 30 according to the embodiment of the invention, more space is provided for the occupant by effectively utilizing the space under the front seat 10, and at the same time, the fuel cell 30 does not obstruct the positioning of the occupant's legs even if the front seat 10 is slid.

Further, in the vehicle 100 according to the embodiment of the invention, the flexible pipe 50, which is deformable and extendable, is used as a pipe that connects the fuel cell 30 with the hydrogen tank 40. Accordingly, the fuel cell 30 can be moved while the hydrogen tank 40 is fixed to the vehicle 100. As a result, the hydrogen tank 40 requires relatively small space.

### B. Modified Examples

While the embodiment of the invention has been described so far, the invention is not limited to the embodiment described above. The invention may be realized in various other embodiments within the scope of the invention. For example, the embodiment may be modified as follows.

### B1. First Modified Example

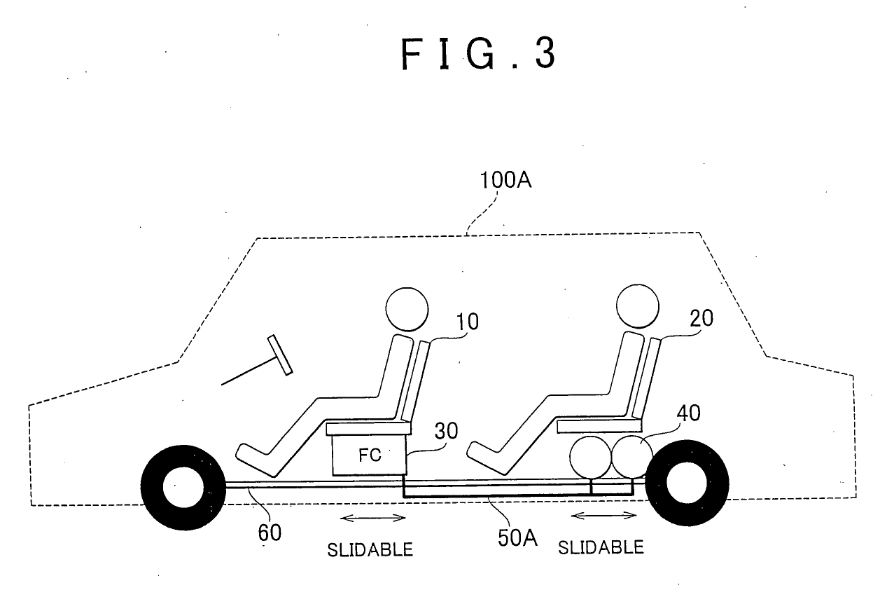

FIG. 3 is the explanatory view schematically showing the structure of a vehicle 100A according to a first modified example of the embodiment. The front seat 10, the rear seat 20, and the positions at which the fuel cell 30 and the hydrogen tank 40 are arranged are common to the vehicle 100A and the vehicle 100. However, the vehicle 100A differs from the vehicle 100 in that the hydrogen tank 40 can be moved with respect to a body of the vehicle 100A by a slide mechanism (not shown), and the fuel cell 30 and the hydrogen tank 40 are connected by a pipe 50A. With this arrangement, when the front seat 10 is slid, the hydrogen tank 40 is also slid together with the front seat 10 and the fuel cell 30.

In the vehicle 100A having the fuel cell 30 according to the first modified example of the embodiment, more space is provided for the occupant by effectively utilizing the space under the front seat 10, and, at the same time, the fuel cell 30 does not obstruct the positioning of the occupant's legs.

In addition, in the vehicle 100A, the hydrogen tank 40 moves in accordance with the movement of the front seat 10 and the fuel cell 30. Accordingly, it is possible to suppress fatigue of the pipe 50A due to its deformation, leading to improved reliability. in pipe strength.

### B2. Second Modified Example

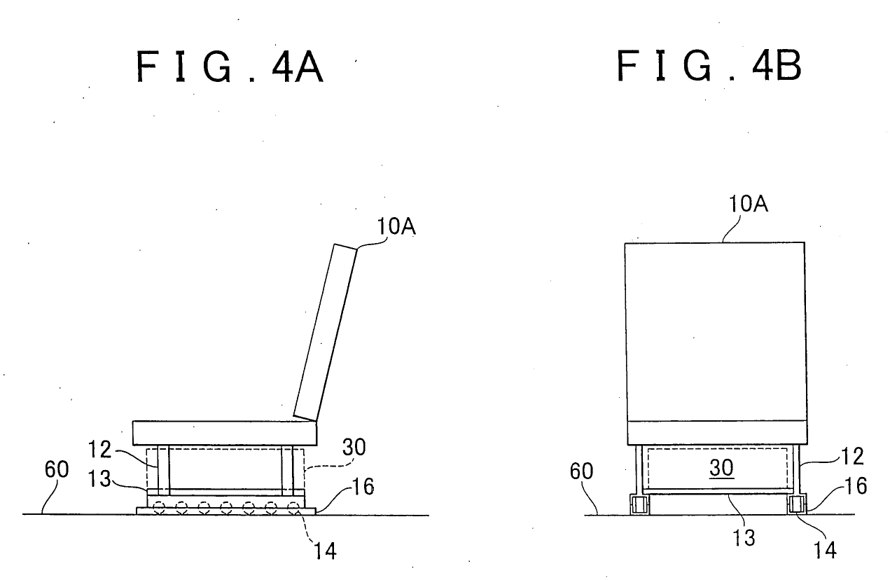

In the embodiment of the invention described above, the fuel cell 30 is fixed to the bottom face of the front seat 10. However, the position at which the fuel cell 30 is attached is not limited to this. FIGS. 4A and 4B are the explanatory views showing the structure of a front seat 10A according to a second modified example of the embodiment, and the position at which the fuel cell 30 is arranged in the second modified example. As shown in FIGS. 4A and 4B, the front seat 10A according to the second modified example is provided with a shelf plate 13. The shelf plate 13 is arranged under the front seat 10A. The fuel cell 30 is arranged on the shelf plate 13 and attached onto the shelf plate 13.

In the vehicle having the fuel cell 30 according to the second modified example of the embodiment, more space is provided for the occupant by effectively utilizing the space under the front seat 10, and at the same time, the fuel cell 30 does not obstruct the positioning of the occupant's legs even when the front seat 10 is slid.

### B3. Third Modified Example:

In the vehicle 100 according to the embodiment of the invention, and the vehicle 100A according to the first modified example of the embodiment, the fuel cell 30 is attached to the front seat 10. However, the position at which the fuel cell 30 is arranged is not limited to this. The hydrogen tank 40 may be arranged at another position in the vehicle. In this case, the rear seat 20 may be slidable backward and forward, and the fuel cell 30 may be attached to the bottom face of the rear seat 20.

### B4. Fourth Modified Example:

The vehicle 100 according to the embodiment of the invention, and the vehicle 100A according to the first modified example of the embodiment are provided with the hydrogen tank 40 from which hydrogen is supplied to the fuel cell 30. However, the hydrogen supply source is not limited to this. Instead of the hydrogen tank 40, for example, a hydrogen generating device that generates hydrogen from a predetermined raw material may be arranged in the vehicle.

### B5. Fifth Modified Example

In the vehicle 100 according to the embodiment of the invention described above, the flexible pipe 50, which is deformable and extendable, is used as the pipe that connects the fuel cell 30 with the hydrogen tank 40. In addition to this pipe, another pipe or a wire connected to the fuel cell, for example, a pipe used to cool a fuel gas discharge portion and the fuel cell and a power cable may be a flexible pipe and a flexible wire that are deformable and extendable.

In the vehicle according to the fifth modified example of the embodiment, more space is provided for the occupant by effectively utilizing the space under the seat, and, at the same time, the fuel cell does not obstruct the positioning of the occupant's legs.

In the embodiment of the invention described above, the seat can be slid with respect to the vehicle body by the slide mechanism with the rollers. The seat may be slid with respect to the vehicle body either manually or electrically.

### B6: Sixth Modified Example:

In the embodiment of the invention, the rear seat 20 is fixed to the floor 60. However, the rear seat 20 does not always have to be fixed to the floor 60. As in the case of the front seat 10, the rear seat 20 may be slid backward and forward with respect to the vehicle body to adjust the seating position of the occupant. Also the hydrogen tank 40 arranged under the rear seat 20 may be movable with respect to the vehicle body so that the hydrogen tank 40 is moved together with the rear seat 40. The fuel cell 30 and the hydrogen tank 40 may be connected to each other by the flexible pipe 50 that is deformable and extensible. Namely, the fuel cell 30 arranged under the front seat 10 and the hydrogen supply source (the hydrogen tank 40) arranged under the rear sear 20 may be moved together with the front seat 10 and the rear seat 20 in accordance with the backward and forward movements of the front seat 10 and the rear seat 20, respectively. Thus, even if the distance between the front seat 10 and the rear seat 20 is changed by sliding the front seat 10 and the rear seat 20, the fuel cell 30 and the hydrogen tank 40 do not obstruct the positioning of the occupant's legs, and the occupant can flexibly adjust the seating position.

1. A vehicle having a fuel cell, comprising:
a seat that is moved with respect to a vehicle body to adjust a seating position of an occupant, wherein
the fuel cell is arranged under the seat and movable together with the seat.

2. The vehicle according to claim 1, further comprising:
a fuel gas supply portion that supplies predetermined fuel gas to the fuel cell, wherein
the fuel gas supply portion is fixed to the vehicle, and
the fuel cell and the fuel gas supply portion are connected to each other by a flexible pipe that is deformable and extensible.

3. The vehicle according to claim 1, further comprising:
a fuel gas supply portion that supplies predetermined fuel gas to the fuel cell, wherein
the fuel gas supply portion is movable with respect to the vehicle body,
the fuel cell and the fuel gas supply portion are connected to each other by a pipe, and
the fuel gas supply portion is moved in accordance with a movement of the seat and the fuel cell.

4. The vehicle according to claim 1, wherein
the seat is provided with a shelf plate arranged under the seat, and the fuel cell is attached onto the shelf plate.

5. The vehicle according to claim 1, further comprising:
a real seat, wherein
the seat is a front seat, the fuel cell is arranged under the front seat, and the fuel gas supply portion is arranged under the rear seat.

6. The vehicle according to claim 2, further comprising:
a fuel gas supply portion that supplies predetermined fuel gas to the fuel cell, wherein
the fuel gas supply portion is movable with respect to the vehicle body,
the fuel cell and the fuel gas supply portion are connected to each other by a pipe, and
the fuel gas supply portion is moved in accordance with a movement of the seat and the fuel cell.

7. The vehicle according to claim 2, wherein
the seat is provided with a shelf plate arranged under the seat, and the fuel cell is attached onto the shelf plate.

8. The vehicle according to claim 3, wherein
the seat is provided with a shelf plate arranged under the seat, and the fuel cell is attached onto the shelf plate.

9. The vehicle according to claim 6, wherein
the seat is provided with a shelf plate arranged under the seat, and the fuel cell is attached onto the shelf plate.

10. The vehicle according to claim 2, further comprising:
a real seat, wherein
the seat is a front seat, the fuel cell is arranged under the front seat, and the fuel gas supply portion is arranged under the rear seat.

11. The vehicle according to claim 3, further comprising:
a real seat, wherein
the seat is a front seat, the fuel cell is arranged under the front seat, and the fuel gas supply portion is arranged under the rear seat.

12. The vehicle according to claim 6, further comprising:
a real seat, wherein
the seat is a front seat, the fuel cell is arranged under the front seat, and the fuel gas supply portion is arranged under the rear seat.

13. The vehicle according to claim 4, further comprising:
a real seat, wherein
the seat is a front seat, the fuel cell is arranged under the front seat, and the fuel gas supply portion is arranged under the rear seat.

14. The vehicle according to claim 7, further comprising:
a real seat, wherein
the seat is a front seat, the fuel cell is arranged under the front seat, and the fuel gas supply portion is arranged under the rear seat.

15. The vehicle according to claim 8, further comprising:
a real seat, wherein
the seat is a front seat, the fuel cell is arranged under the front seat, and the fuel gas supply portion is arranged under the rear set.

16. The vehicle according to claim 9, further comprising:
a real seat, wherein
the seat is a front seat, the fuel cell is arranged under the front seat, and the fuel gas supply portion is arranged under the rear seat.
